(19) United States
(12) Patent Application Publication
(10) Pub. No.: US 2015/0102954 A1
(43) Pub. Date: Apr. 16, 2015

(54) 4-DIMENSIONAL CONTINUOUS WAVE RADAR SYSTEM FOR TRAFFIC SAFETY ENFORCEMENT

(71) Applicant: Lang Hong, Beavercreek, OH (US)

(72) Inventor: Lang Hong, Beavercreek, OH (US)

(21) Appl. No.: 14/227,967

(22) Filed: Mar. 27, 2014

Related U.S. Application Data
(60) Provisional application No. 61/890,267, filed on Oct. 13, 2013.

(51) Int. Cl. G01S 13/06

(52) U.S. Cl. CPC G01S 13/06
USPC 342/59

(57) ABSTRACT

A radar system for detecting a single object from a plurality of objects and calculating 4D information of said object may include a first radar for obtaining first positional information of a first object, a second radar for obtaining second positional information of a second object and a computer for comparing the first positional information with the second positional information to determine if the first object is the same as the second object and combining the matched first positional and second positional information into 4D information.

### PRIORITY

The present invention claims priority under 35 USC section 119 based upon a provisional application with a Ser. No. 61/890,267 which was filed on Oct. 13, 2013.

### FIELD OF THE INVENTION

This invention relates to a 4-dimensional (4D) continuous wave radar system which can provide 4D information of a moving object: range, range rate, azimuth angle and elevation angle.

### BACKGROUND

Traditionally, 3D information of a moving object (range, rage rate and azimuth angle) can be derived from a continuous wave radar which has multiple transmitting antennas and multiple receiving antennas using a waveform modulation method, such as Frequency Shift Keying (FSK) method or Frequency Modulated Continuous Wave (FMCW) method. FIG. 1 presents an example of continuous wave radar with one transmitting antenna and two receiving antennas for 3-dimensional (3D) information sensing. The 3D information of the moving object is: range (r), range rate (v_{d}) and angle (θ).

### SUMMARY

A radar system for detecting a single object from a plurality of objects and calculating 4D information of said object may include a first radar for obtaining first positional information of a first object, a second radar for obtaining second positional information of a second object and a computer for comparing the first positional information with the second positional information to determine if the first object is the same as the second object and combining the matched first positional and second positional information into 4D information.

The first radar may be a horizontal radar.

The second radar may be a vertical radar.

The first positional information may include range information.

The second positional information may include range information.

The first positional information may include azimuth angle information.

The second positional information may include elevational angle information.

The first positional information may include range rate information.

The second positional information may include range rate information.

The first positional information may be compared to the second positional information includes first range information from the first radar being compared to second range information from the second radar.

The first positional information may be compared to the second positional information includes first range rate information from the first radar being compared to second range rate information from the second radar.

The matched first positional information and second positional information may be combined into 4D information.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a continuous wave radar for three-dimensional information;

FIG. 2 illustrates a 4D continuous wave radar of the present invention for a singular moving object;

FIG. 3 illustrates a 4D continuous wave radar of the present invention for multiple moving objects;

FIG. 4 illustrates a flowchart of the present invention.

### DETAILED DESCRIPTION

In many applications, 4D information (range, range rate, azimuth and elevation angles) of a moving object is needed. No existing continuous wave radar device can provide such 4D information. The present invention presents a system using a horizontal 3D radar and a vertical 3D radar in a perpendicular configuration to derive 4D information of a moving object. Both horizontal and vertical radars could have multiple transmitters and receivers.

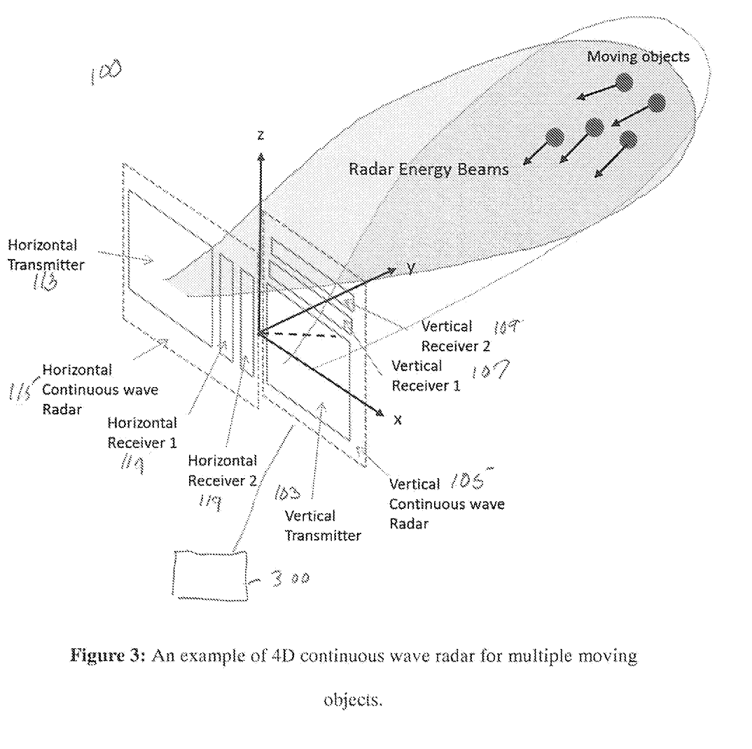

The 4D information of the moving object can be derived by combining the 3D information from both horizontal and vertical radars. For a single moving object, this is trivial; but for multiple moving objects within both horizontal and vertical radar energy beams (as shown in FIG. 3), a more challenging task is to find the signals in both horizontal and vertical radar corresponding to the same moving object.

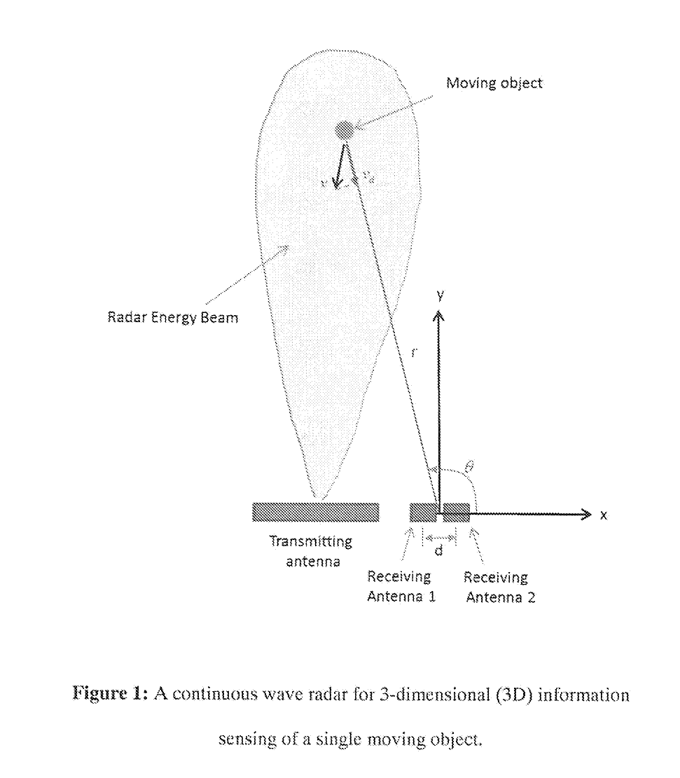

An example of deriving 3D information of a moving object is illustrated in FIG. 1. The range (distance)

$$r = \frac{c Δ ϕ}{4 π Δ f}$$

and range rate (speed) can be derived either using FSK method:
(1)

and v_{d}=K_{d}f_{D} (2)

where c is the speed of light, Δφ and Δf are the phase and frequency differences between two-step signals of FSk, f_{D} is the Doppler frequency and K_{D} is conversion constant, or using FMCW method:

$$\begin{matrix}r = \frac{( {f}_{Dup} + {f}_{Ddown} ) T Δ r}{2} \\ and & ( 3 ) \\ {v}_{d} = \frac{( {f}_{Dup} - {f}_{Ddown} ) T Δ v}{2} & ( 4 )\end{matrix}$$

where f_{Dup} and f_{Ddown} are up and down beat frequencies, T is the triangle waveform period, and Δr and Δv are range and range rate resolutions. The angle of the moving object with respect to the radar, θ, can be calculated as

$$θ = {sin}^{- 1} ( \frac{λ}{2 π d} Δ φ ) \qquad ( 5 )$$

Where λ is the emitted electromagnetic wave length, d is the distance between two receiving antenna centers, Δφ is the phase difference between the two signals received at two receiving antennas.

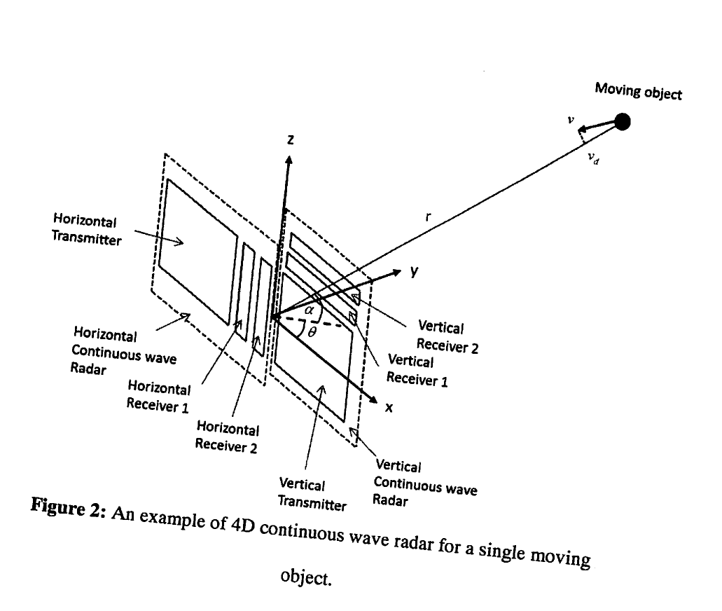

FIG. 2 shows an example of 4D continuous wave radar for a single moving object, where both the horizontal and vertical radars have one transmitter and two receivers.

Each 3D radar delivers a set of 3D information. The horizontal radar generates range (rₕ), range-rate (v_{dh}) and azimuth angle (θ), and the vertical radar yields range (rᵥ), range-rate (v_{dv}) and elevation angle (α). The range and range rate are calculated by either Equations (1) and (2) or (3) and (4). The azimuth and elevation angles are calculated by Equation (5).

In FIG. 3, a 4D radar system 100 is shown to detect a moving object from multiple moving objects. More particularly, the system 100 of the present invention may detect positional information on a single object which may be moving in a field of moving multiple objects. The system 100 may include a vertical continuous wave radar 105 which may be positioned substantially adjacent or adjacent and perpendicular to a horizontal continuous wave radar 115. The vertical continuous wave radar 105 may include a vertical transmitter 103 which may extend across the substantially width of the vertical continuous wave radar 105, a first vertical receiver 107 which may extend across the top or bottom of the vertical transmitter 103 and a second vertical receiver 109 which may extend across the top or bottom of the first vertical receiver 107. The horizontal continuous wave radar 115 may include a horizontal transmitter 113 which may extend across the substantial height of the horizontal continuous wave radar 115, the first horizontal receiver 117 which may be adjacent to the horizontal transmitter 113 and extend across the substantial height of the horizontal transmitter 113 and the second horizontal receiver 119 which may be adjacent to the first horizontal receiver 117 and may extend across the substantial height of the horizontal transmitter 113.

The present invention includes a computer 300 to operate a signal matching algorithm to identify the signals from two radars corresponding to the same moving object using physical constraints such as matching data: for example same range and same range-rate for the same moving object over a time window.

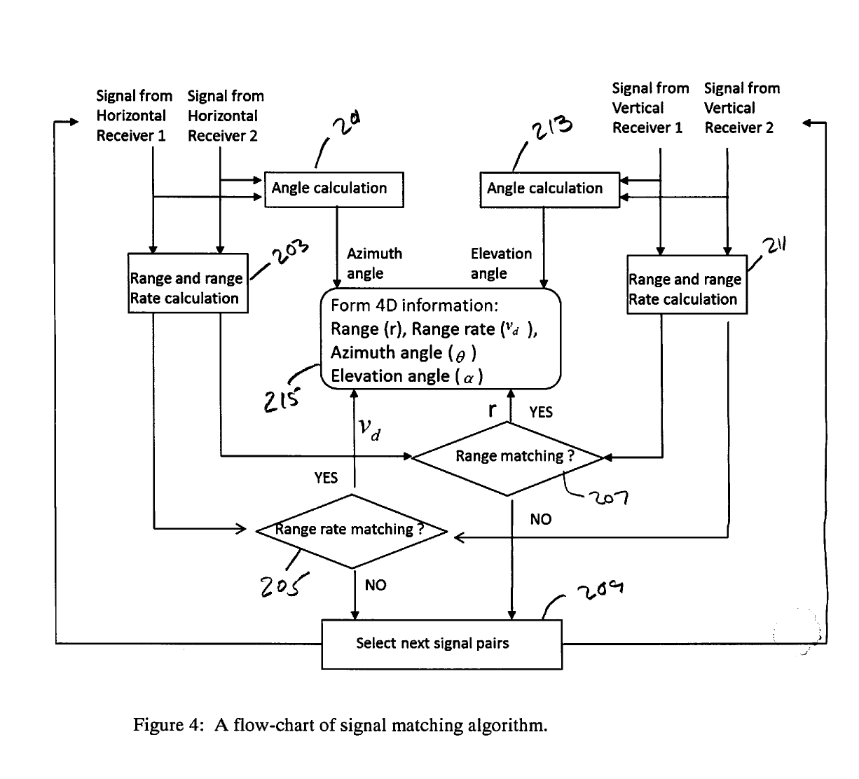

FIG. 4 presents a flow chart of the signal matching algorithm.

The signal from the first horizontal receiver 117 and the signal from the second horizontal receiver 119 are used to obtain a range (equation 1) and range rate (equation 2) value from the range and range rate calculation in step 203. More particularly a horizontal range and horizontal range rate value is calculated in step 203. The signal from the first horizontal receiver 117 and the signal from the second horizontal receiver 119 are used to obtain an azimuth angle from the angle calculation (equation 5) in step 201 The signal from the first vertical receiver 107 and the signal from the second vertical receiver 109 are used to obtain a range (equation 1) and range rate (equation 2) value from the range and range rate calculation in step 211. A vertical range and vertical range rate value is calculated in step 211. The signal from the first vertical receiver and 107 and the second vertical receiver 109 are used to obtain an elevation angle from the angle calculation (equation 5) in step 213.

The range (distance from the radar to the moving object) of the horizontal radar 115 and the range of the vertical radar 105 and the range rate (velocity of the moving target assuming the radar is stationary) of the horizontal radar 115 and the vertical radar 105 are used to determine if the object detected by the horizontal radar 115 is the same object detected by the vertical radar 105. From the step 203 and step 211, the range of the horizontal radar 115 is compared with the range of the vertical radar 105 in step 207. If the two ranges are the same or substantially the same, control passes to step 215, and if the two ranges are dissimilar, control passes to step 209 indicating different objects and another object is selected to be tested.

From the step 203 and step 211, the range rate of the horizontal radar 115 is compared with the range rate of the vertical radar 105 in step 205. If the two range rates are the same or substantially the same, control passes to step 215 indicating that the horizontal radar and the vertical radar both have identified the same object. If the range rates are different, then control passes to step 209 indicating that the horizontal radar and the vertical radar have identified different objects. Other objects are chosen for identification.

The matched signals from step 205 and step 207 are combined in step 215 into 4D information of the identified object: range, range rate, azimuth angle and elevational angle.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A radar system for detecting a single object from a plurality of objects and calculating 4D information of said object, comprising:
a first radar for obtaining first positional information of a first object;
a second radar for obtaining second positional information of a second object;
a computer for comparing the first positional information with the second positional information to determine if the first object is the same as the second object and combining the matched first positional and second positional information into 4D information.

2. A radar system for detecting a single object from a plurality of objects and calculating 4D information of said object as in claim 1, wherein the first radar is a horizontal radar.

3. A radar system for detecting a single object from a plurality of objects and calculating 4D information of said object as in claim 1, wherein the second radar is a vertical radar.

4. A radar system for detecting a single object from a plurality of objects and calculating 4D information of said object as in claim 1, wherein the first positional information includes range information.

5. A radar system for detecting a single object from a plurality of objects and calculating 4D information of said object as in claim 1, wherein the second positional information includes range information.

6. A radar system for detecting a single object from a plurality of objects and calculating 4D information of said object as in claim 1, wherein the first positional information includes azimuth angle information.

7. A radar system for detecting a single object from a plurality of objects and calculating 4D information of said object as in claim 1, wherein the second positional information includes elevational angle information.

8. A radar system for detecting a single object from a plurality of objects and calculating 4D information of said object as in claim 1, wherein the first positional information includes range rate information.

9. A radar system for detecting a single object from a plurality of objects and calculating 4D information of said object as in claim 1, wherein the second positional information includes range rate information.

10. A radar system for detecting a single object from a plurality of objects and calculating 4D information of said object as in claim 1, wherein the first positional information being compared to the second positional information includes first range information from the first radar being compared to second range information from the second radar.

11. A radar system for detecting a single object from a plurality of objects and calculating 4D information of said object as in claim 1, wherein the first positional information being compared to the second positional information includes first range rate information from the first radar being compared to second range rate information from the second radar.

12. A radar system for detecting a single object from a plurality of objects and calculating 4D information of said object as in claim 1, wherein the matched first positional information and second positional information is combined into 4D information.
